(19) United States
(12) Patent Application Publication
(10) Pub. No.: US 2024/0129346 A1
(43) Pub. Date: Apr. 18, 2024

(54) METHOD, APPARATUS AND SYSTEM FOR ASSOCIATING DIFFERENT INSTANCES OF USER ENGAGEMENT WITH A CONTENT PROVIDER

(71) Applicant: Novatiq Technologies Limited, Cwmbran (GB)

(72) Inventors: Tanya May FIELD, Cwmbran (GB); Simon CONWAY-SMITH, Cwmbran (GB)

(21) Appl. No.: 18/398,908

(22) Filed: Dec. 28, 2023

Related U.S. Application Data
(63) Continuation of application No. PCT/GB2022/051654, filed on Jun. 28, 2022.

(30) Foreign Application Priority Data
Jul. 1, 2021 (GB) GB2109541.9

(51) Int. Cl. H04L 65/40; H04L 67/50

(52) U.S. Cl. CPC H04L 65/40; H04L 67/535

(57) ABSTRACT

A method comprises, for a first instance of user engagement with a content provider, and at a first entity within a service provider network, receiving a first message comprising a first ID associated with the provision of content from the content provider; identifying the subscriber and determining an identifier for the subscriber; and transmitting the identifier for the subscriber and the first ID to a second entity. The first ID is stored in association with the identifier for the subscriber. This is repeated for a second instance based on the receipt of a second message comprising a second ID from the or another subscriber device of the subscriber. The second ID is stored with the subscriber identifier and thereby with the first ID. Information indicating the stored association is provided to the content provider, thereby to allow the content provider to associate the first instance with the second instance.

### CROSS-REFERENCE TO RELATED APPLICATIONS

This application is a continuation under 35 U.S.C. § 120 of International Application No. PCT/GB2022/051654, filed Jun. 28, 2022, which claims priority to GB Application No. GB2109541.9, filed Jul. 1, 2021, under 35 U.S.C. § 119(a). Each of the above-referenced patent applications is incorporated by reference in its entirety.

### BACKGROUND

### Technical Field

The present invention relates to a method, apparatus and system for associating different instances of user engagement with a content provider.

### Background

A user may use a device, such as a personal computer or smart phone, to engage with a content provider over the internet. As an example of engagement of a user with a content provider, a user may control a browser of the device to send, over a computer network such as the internet, a request for content to the content provider (e.g. by entering a URL of the content provider into the browser), and the content provider may send a response, including the content (e.g. a web page), over the computer network, back to the user device for the user view and interact with.

Where there are multiple instances of such engagement of the user with the content provider (e.g. multiple request and response cycles), it is desirable for the content provider to know that each engagement is with the same user. For example, this may allow a website provided by the content provider to work more efficiently. For example, this may allow the content provider to provide continuity across the instances of engagement (e.g. maintaining a login or a shopping cart across the instances of engagement), and/or to provide accurate analytics such as how many unique users have engaged with the content provider or how each user interacts with the content provider.

It is known to use cookies to identify a user across multiple instances of engagement with a content provider. A cookie is a packet of data sent by the content provider to the browser of the user device, which is returned by the browser each time the browser subsequently accesses the content provider, used to identify the user or track the users access to the content provider. A cookie that is set by the domain that the user is engaging with (i.e. the content provider) is known as a first-party cookie.

However, cookies have drawbacks. As one example, a cookie is set on a browser of a particular device of a user. Therefore, the cookie does not allow the content provider to know when the same user is engaging with the content provider, but using different devices. As another example, cookies expire. For example, browsers delete cookies once a session is closed or after a certain time, or the cookies themselves are set to expire after a certain time. Therefore, even if the same device is used across different instances of engagement, depending on the deletion and/or expiry of the cookie, the cookie may not allow the content provider to know when the same user engaging with the content provider, but at different times.

It is an object of the invention to mitigate at least some of the drawbacks of the prior art.

### SUMMARY

According to a first aspect of the present invention, there is provided a method for associating different instances of engagement of a subscriber of a service provider network with a first content provider, the method comprising: for a first instance: at a first entity within the service provider network: receiving a first message from a subscriber device of the subscriber, the first message comprising a first ID associated with the provision of content from the first content provider to the subscriber device in the first instance; identifying the subscriber based on the received first message; determining an identifier for the subscriber based on the identification of the subscriber; and transmitting the identifier for the subscriber and the first ID to a second entity; at the second entity: storing the first ID in association with the identifier for the subscriber; for a second instance: at the first entity within the service provider network: receiving a second message from the subscriber device or another subscriber device of the subscriber, the second message comprising a second ID different to the first ID, the second ID being associated with the provision of content from the first content provider to the subscriber device or the other subscriber device in the second instance; identifying the subscriber based on the received second message; determining the identifier for the subscriber based on the identification of the subscriber; and transmitting the identifier for the subscriber and the second ID to the second entity; at the second entity: storing the second ID in association with the identifier for the subscriber and thereby in association with the first ID; wherein the method further comprises, at the second entity: providing, to a third entity associated with the first content provider, information indicating the stored association between the second ID and the first ID, thereby to allow the third entity to associate the first instance with the second instance.

Optionally, the first ID is generated when the subscriber device obtains the content from the first content provider in the first instance, and/or the second ID is generated when the subscriber device or the other subscriber device obtains the content from the first content provider in the second instance.

Optionally, the first ID is generated by the first content provider and provided to the subscriber device when the subscriber device obtains the content from the first content provider in the first instance; and/or the second ID is generated by the first content provider and provided to the subscriber device or the other subscriber device when the subscriber device or the other subscriber device obtains the content from the first content provider in the second instance.

Optionally, the first ID is stored as a cookie on the subscriber device by the first content provider; and/or the second ID is stored as a cookie on the subscriber device or the other subscriber device by the first content provider.

Optionally, content obtained by the subscriber device from the first content provider in the first instance includes code or a link to code that causes the subscriber device to send the first message to the first entity in the service provider network; and/or the content obtained by the subscriber device or the other subscriber device from the first content provider in the second instance includes code or a link to code that causes the subscriber device or the other subscriber device to send the second message to the first entity in the service provider network.

Optionally, the second message is received from the other subscriber device, and wherein the second ID is associated with the provision of content from the first content provider to the other subscriber device in the second instance.

Optionally, the second message is received from the subscriber device, wherein the second ID is associated with the provision of content from the first content provider to the subscriber device in the second instance, and wherein the second instance is at a different time to the first instance.

Optionally, the second entity is external to the service provider network, and wherein: for the first instance: identifying the subscriber based on the first message at the first entity comprises determining a first subscriber identifier for the subscriber that identifies the subscriber within the service provider network; determining the identifier for the subscriber based on the identification of the subscriber comprises deriving, based on the first subscriber identifier, a second subscriber identifier for the subscriber that identifies the subscriber at the second entity; and wherein the method comprises: at the first entity, modifying the first message to include the second subscriber identifier; and sending the modified first message to the second entity for the second entity to use in storing the first ID in association with the identifier for the subscriber; and for the second instance: identifying the subscriber based on the second message at the first entity comprises determining the first subscriber identifier for the subscriber; determining the identifier for the subscriber based on the identification of the subscriber comprises deriving, based on the first subscriber identifier, the second subscriber identifier for the subscriber; and wherein the method comprises: at the first entity, modifying the second message to include the second subscriber identifier; and sending the modified second message to the second entity for the second entity to use in storing the second ID in association with the identifier for the subscriber.

Optionally, the method further comprises: for the first instance: at the second entity, storing the first ID in association with the second subscriber identifier; and
for the second instance: at the second entity, storing the second ID in association with the second subscriber identifier.

Optionally, for the first instance: where a said second subscriber identifier for the subscriber is already stored in association with the first subscriber identifier at the first entity, deriving the second subscriber identifier comprises using the first subscriber identifier to look up the second subscriber identifier; and/or where no said second subscriber identifier for the subscriber is already stored in association with the first subscriber identifier at the first entity, deriving the second subscriber identifier comprises generating the second subscriber identifier for the first subscriber identifier.

Optionally, the first message and the second message each include a third ID identifying the first content provider from which the content is provided, and wherein the method comprises: for the first and second instance: at the second entity, storing the third ID in association with the first ID and the second ID, respectively.

Optionally, providing the information indicating the association between the second ID and the first ID to the third entity is responsive to a determination that the first ID and the second ID are stored in association with the third ID.

Optionally, the first message and the second message include consent information associated with the first ID and the second ID, respectively, the consent information for the first ID and the second ID indicating whether or not the subscriber consents to the use of their identification by the service provider network for the first ID and the second ID, respectively; and wherein the method comprises: for the first and second instance: at the second entity, storing the consent information for the first ID in association with the first ID and storing the consent information for the second ID in association with the second ID, respectively.

Optionally, providing the information indicating the association between the second ID and the first ID to the third entity is responsive to a determination, based on the stored consent information for the first ID and the second ID, that there is a valid consent for the use of the identification of the subscriber by the service provider network for the first ID and the second ID.

Optionally, the consent information for the first ID comprises a consent expiry for the first ID and the consent information for the second ID comprises a consent expiry for the second ID, and wherein determining that there is a valid consent for the first ID and the second ID is based on a comparison of the stored consent expiry for the first ID and the second ID with a current time.

Optionally, the method comprises updating the stored consent expiry for the first ID based on the consent information associated with the second ID included in the second message.

Optionally, the method comprises, for a third instance: at the second entity, receiving a third message comprising the first ID and updated consent information associated with the first ID or comprising the second ID and updated consent information associated with the second ID; and at the second entity, updating the stored consent information for the first ID or for the second ID based on the updated consent information associated with the first ID and/or the second ID, respectively.

Optionally, the third message is received by the second entity from a subscriber device via an access network other than the service provider network and without passing through the service provider network.

Optionally, the method comprises: at the second entity, receiving, from the third entity, the first ID and/or the second ID in association with a browsing attribute indicating an attribute of said engagement of the subscriber with the first content provider in the first and/or second instance, respectively; at the second entity, determining the identifier for the subscriber associated with the browsing attribute based on the received first ID and/or second ID and the stored association between the first ID, the second ID and the identifier for the subscriber; at the second entity, storing the browsing attribute in association with the identifier for the subscriber; and at the second entity, providing, to an advertising entity, segment information indicating at least the browsing attribute.

Optionally, the method comprises: at the second entity, receiving a token from the advertising entity, the token having been provided to the advertising entity by a subscriber device of the subscriber when the subscriber device of the subscriber requests an advert; and at the second entity, matching the token from the advertising entity with a token stored at the second entity in association with the identifier for the subscriber; wherein providing to the advertising entity the segment information indicating at least the browsing attribute is responsive to the matching of the token.

According to a second aspect of the present invention, there is provided a system for associating different instances of engagement of a subscriber of a service provider network with a first content provider, the system comprising: a first entity within a service provider network; and a second entity, wherein, the first entity is configured to: for a first instance, receive a first message from a subscriber device of the subscriber, the first message comprising a first ID associated with the provision of content from the first content provider to the subscriber device in the first instance; identify the subscriber based on the received first message; determine an identifier for the subscriber based on the identification of the subscriber; and transmit the identifier for the subscriber and the first ID to the second entity; and for a second instance, receive a second message from the subscriber device or another subscriber device of the subscriber, the second message comprising a second ID different to the first ID, the second ID being associated with the provision of content from the first content provider to the subscriber device or the other subscriber device in the second instance; identify the subscriber based on the received second message; determine an identifier for the subscriber based on the identification of the subscriber; and transmit the identifier for the subscriber and the second ID to the second entity; wherein the second entity is configured to: for the first instance, store the first ID in association with the identifier for the subscriber; for the second instance, store the second ID in association with the identifier for the subscriber and thereby in association with the first ID; and provide, to a third entity associated with the first content provider, information indicating the stored association between the second ID and the first ID, thereby to allow the third entity to associate the first instance with the second instance.

According to a third aspect of the present invention, there is provided a method for associating different instances of engagement of a subscriber of a service provider network with a first content provider, the method comprising, at a second entity: for a first instance: storing a first ID in association with an identifier for the subscriber, the first ID having been included in a first message received from a subscriber device by a first entity within the service provider network, the subscriber having been identified, by the first entity, based on the first message, the identifier for the subscriber having been determined, by the first entity, based on the identification of the subscriber, the first ID and the identifier for the subscriber having been transmitted by the first entity to the second entity, the first ID being associated with the provision of content from the first content provider to the subscriber device in the first instance; for a second instance: storing a second ID in association with the identifier for the subscriber and thereby in association with the first ID, the second ID having been included in a second message received from the subscriber device or another subscriber device by the first entity, the subscriber having been identified, by the first entity, based on the second message, the identifier for the subscriber having been determined, by the first entity, based on the identification of the subscriber, the second ID and the identifier for the subscriber having been transmitted by the first entity to the second entity, the second ID being associated with the provision of content from the first content provider to the subscriber device or the other subscriber device in the second instance; and wherein the method further comprises, at the second entity: providing, to a third entity associated with the first content provider, information indicating the stored association between the second ID and the first ID, thereby to allow the third entity to associate the first instance with the second instance.

According to a fourth aspect of the present invention, there is provided method for associating different instances of engagement of a subscriber of a service provider network with a first content provider, the method comprising, at a third entity associated with the first content provider: for a first instance: recording a first ID associated with the provision of content from the first content provider to a subscriber device in a first instance; for a second instance: recording a second ID associated with the provision of content from the first content provider to the subscriber device or another subscriber device in a second instance; receiving, from a second entity, information indicating an association between the first ID and the second ID, the first ID and the second ID having been stored by the second entity in association with an identifier for the subscriber, the subscriber having been identified, by a first entity within the service provider network, based on a first message, comprising the first ID, received from a subscriber device and based on a second message, comprising the second ID, received from the subscriber device or another subscriber device, the identifier for the subscriber having been determined, by the first entity, based on the identification of the subscriber, the first ID and the identifier for the subscriber having been transmitted from the first entity to the second entity, the second ID and the identifier for the subscriber having been transmitted from the first entity to the second entity; and associating the first instance with the second instance based on the received information indicating the association between the first ID and the second ID.

According to a fifth aspect of the present invention, there is provided apparatus configured to perform the method according to the third aspect or the fourth aspect.

According to a sixth aspect of the present invention, there is provided a computer readable medium having instructions stored thereon which, when executed by a computer system, cause the computer system to perform the method according to any one of the first aspect, third aspect or fourth aspect.

Further features and advantages of the invention will become apparent from the following description of preferred examples of the invention, given by way of example only, which is made with reference to the accompanying drawings.

### BRIEF DESCRIPTION OF THE DRAWINGS

FIG. 1 is a diagram illustrating schematically a network according to an example;

FIG. 2 is a signalling diagram illustrating schematically communication between components of the network, according to an example;

FIG. 3 is a signalling diagram illustrating schematically communication between components of the network, according to another example;

FIG. 4 is a flow diagram illustrating schematically a method according to an example;

FIG. 5 is a schematic diagram illustrating an identifier graph according to an example;

FIG. 6 is a flow diagram illustrating schematically a method according to an example;

FIG. 7 is a flow diagram illustrating schematically a method according an example;

FIG. 8 is a diagram illustrating schematically a network according to an example;

FIG. 9 is a signalling diagram illustrating schematically communication between components of the network, according to an example; and

FIG. 10 is a diagram illustrating schematically an apparatus according to an example.

### DETAILED DESCRIPTION

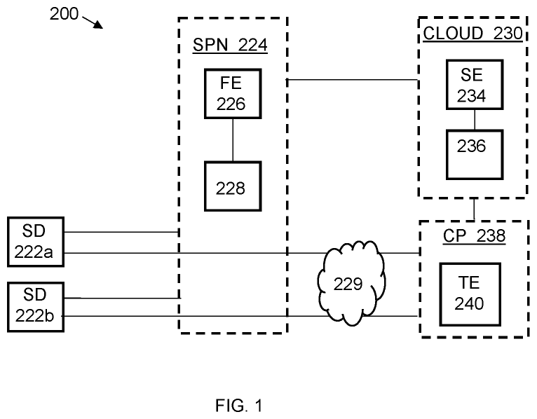

Referring to FIG. 1, there is illustrated an example telecommunications network 200 in which examples of the present invention may be employed.

The telecommunications network 200 comprises a first subscriber device 222a, a second subscriber device 222b, a service provider network 224, a cloud 230, a computer network such as the internet 229, and a content provider 238. The service provider network 224 comprises a first entity 226 and a data store 228. The cloud 230 comprises a second entity 234 and a data store 236. The content provider 238 comprises a third entity 240.

The service provider network 224 is operated by a telecommunications service provider. A subscriber subscribes to a telecommunications service provided by the telecommunications service provider to gain access to the internet 229. The telecommunications service may provide access to the internet 229 for a given subscriber device 222a, 222b, a group of subscriber devices 222a, 222b, or a residential or commercial premises network associated with a given subscriber. The service provider network 224 may, for example, perform subscriber authentication and may comprise a routing fabric for routing traffic between an authenticated subscriber device 222a, 222b and the internet 229. A service provider may comprise, for example, a carrier, a mobile network operator (MNO), a wireless network operator or an internet service provider (ISP). The subscriber devices 222a, 222b may be, for example, a personal computer, laptop computer, mobile telephone (including a “smart phone”), tablet computer, personal digital assistant, or Smart TVs.

In some examples, the service provider network 224 may comprise a carrier network operated by a carrier. A carrier network may provide wired and/or wireless network access. For example, a carrier network may comprise a mobile network and/or an internet service provider (ISP).

In some examples, the service provider network 224 may comprise a mobile network (which may be in the form of a cellular network) operated by a mobile network operator (MNO). For example, the service provider network 224 may comprise one or more of a Global System for Mobile Communications (GSM) network and a Universal Mobile Telecommunications System (UMTS) network, e.g. implementing one of the Long-Term Evolution (LTE) standards. The service provider network 224 may comprise a radio access network and a core network, e.g. as coupled by one or more service edge components. The radio access network may comprise one or more base stations (such as node base-stations—NBs—or enhanced node base-stations—eNBs). Subscriber devices 222a, 222b, such as user equipment (e.g. in the form of mobile telephones, so-called smartphones, laptops and tablets, amongst others) may attach to the core network via the radio access network. The core network may comprise a serving gateway, a packet data network gateway and a gateway general packet radio service (GPRS) support node. Subscriber devices 222a, 222b may connect to other public packet switched networks, e.g. the Internet 229, via the core network of the service provider. Entities, such as the first entity 226 in the service provider network 224, may be responsible for authentication of subscribers/subscriber devices 222a, 222b, access management, billing, etc. This may be performed in association with a home subscriber server or user profile server function (or an authentication centre for GSM) within the service provider network 224.

In some examples, the service provider network 224 comprises an internet service provider network operated by an ISP. An ISP may provide wired network access, e.g. via dial-up, (asymmetric) digital subscriber lines, cable modems, integrated services digital networks and/or fibre-optic lines.

In some examples, the service provider network 224 may alternatively or additionally provide telecommunications services in the form of wireless network (e.g. “wi-fi”) access to at least one subscriber device 222a, 222b; this may be instead of, or in addition to, mobile access (e.g. by an MNO) and/or ISP functions. The wider network 229 is responsible for routing traffic (e.g. packetized data traffic encoded according to the Hypertext Transfer Protocol (HTTP) or a secure extension of HTTP, such as HTTPS) to and from one or more entities accessible via the internet 229, such as the content provider 238 and the cloud 230.

In any case, the service provider network 224 may act as a gateway between subscriber devices 222a, 222b and the wider network 229, such as the public internet 229. The wider network 229 may, at least in part, be used to route data between service provider network 224 and the content provider 238 and/or one or more other server devices 234.

The telecommunications network 200 may also comprise a number of further network parts (not shown), and a number of border/gateway/caching entities (not shown) used to translate between the various network protocols used in each network part where necessary, cache and serve commonly-accessed data so as to reduce load between network parts, and/or manage access to each network part.

Access by the subscriber devices 222a, 222b to data and/or computer-implemented services via telecommunications network 200 may be enabled using browser software or other applications (hereinafter “a browser”) on the subscriber devices 222a, 222b. Other applications on the subscriber devices 222a, 222b may include games or software utilities that also access content via telecommunications network 200. For example, a user may control the browser to send a request for content to the content provider (e.g. by entering a URL of the content provider into the browser), and the content provider 238 may send a response, including the content (e.g. a web page), back to the user device for the user view and interact with. A browser session of one of the subscriber devices 222a, 222b may comprises a series of one or more requests and responses made to and received from one or more remote entities, such as the content provider 238, via telecommunications network 200. The browser may be used to view web pages, obtain files, conduct services such as instant messaging, etc. via telecommunications network 200. Browser session requests and responses may comprise one or more data packets. Such packetized data is formatted and transported according to one or more network protocols, used in a given part of the network.

The content provider 238 comprises a third entity 240. The third entity 240 may be a web server 240. The third entity 240 may be configured to provide content to the subscriber devices 222a, 222b. The third entity 240 may be configured to determine analytics of engagement with the content provider 238. For example, the third entity 240 may comprise a data management platform (DMP) for the content provider 238, by which the content provider 238 determined and stores analytics of engagement with the content provider 238. Although only one third entity 240 is shown, it will be appreciated that the content provider 238 may comprise multiple more web servers. The content provider 238 is external to the service provider network 224.

The content provider 238 and the subscriber devices 222a, 222b may exchange network requests and responses such that content is provided to the subscriber devices 222a, 222b. In this example, network requests and responses between the subscriber devices 222a, 222b and the content provider 238 are communicated via the service provider network 224 and the wider network 229, which may be, for example, the Internet. In some examples, network requests may not be browser based, e.g. may relate to, amongst others: voice and/or data requests that are processed by the service provider network; location requests to a positioning system; and/or network requests transmitted by one or more applications or operating systems on the subscriber device 222a, 222b.

In some examples, each network request may comprise a HTTP request sent between two entities in the network 200. A browser session may, as such, comprise an HTTP session. The HTTP request may comprise a GET or POST method call. In other implementations, the network request may comprise packets of data sent by another application layer protocol or by another protocol in a network communication stack.

In examples, the subscriber devices 222a, 222b and the content provider 238 may communicate via a secure communications channel such that the service provider network 224 may route messages between the subscriber devices 222a, 222b and the content provider 238 but is unable to read the content of the messages. For example, the subscriber device 222a, 222b and content provider 238 may communicate by exchanging messages using a suitable secure Layer 7 communication protocol, for example, HTTPS. Routing via the service provider network 224 as described herein may be implemented using policy-based routing based on an IP address of a network request.

The cloud 230 comprises a second entity 234 and a storage 236. The second entity 234 may be implemented by one or more servers, for example cloud based web servers. The cloud 230, and specifically the second entity 234, is in communication with the content provider 240 and the service provider network 224. The second entity 234 may have an established, e.g. trusted, relationship with the service provider network 224. For example, as described in more detail below, the service provider network 224 may be configured to provide information on subscribers of the service provider network 224 to the second entity 234. The second entity 234 may have an established, e.g. trusted, relationship with the content provider 238. For example, as described in more detail below, the second entity 234 and the content provider 238 may exchange information to allow the content provider 238 to associate different instances of engagement of a subscriber with the content provider 238.

As mentioned, the subscriber subscribes to the service provider network 224 (e.g. Mobile Network Operator, MNO, or Internet Services Provider, ISP) in order that access to the internet 229 be provided thereby. In order to provide this service, the service provider network 224 may store data on the subscribers to the service provider network 224, for example in the storage 228. Each subscriber to the service provider network 224 may be assigned an identifier (also referred to herein as the first subscriber identifier) that uniquely identifies the subscriber amongst other subscribers of the service provider network 224. The subscriber identifier may be stored by the service provider network 224, e.g. in the storage 228, in association with other data to enable the service provider network 224 to provide its services. As one example, the subscriber identifier may be stored in association with an IP address or range of IP addresses, for which an ISP provides its services to the subscriber. For example, the IP address or address range may be that assigned to the subscriber premises by the ISP. The ISP may therefore determine, for requests and/or responses from/to subscriber devices 222a, 222b including this IP address or an IP address from the range of IP addresses, that the request/response is associated with the subscriber, and hence may for example, implement charging or other functions accordingly. As another example, the subscriber identifier may be stored in association with an International Mobile Equipment Identity (IMEI) of a subscriber device 222a, 222b, for which an MNO provides its services to the subscriber. The MNO may therefore determine, for requests and/or responses from/to a subscriber device 222a, 222b including this IMEI, that the request/response is associated with the subscriber, and hence may, for example, implement charging or other functions accordingly.

Where there are multiple instances of engagement of a user with the content provider 238 (e.g. multiple request and response cycles, or multiple browser sessions), it may be desirable for the content provider 238 to know that each instance of engagement is with the same user. In broad overview, as described in more detail below, by utilising an identification of the subscriber by the service provider network 224, examples of the present invention allow for a content provider 238 to associate different instances of engagement of the subscriber with the content provider 238. The content provider 238 may therefore know that each such instance of engagement is with the same subscriber. This may, for example, allow a website provided by the content provider 238 to work more efficiently. For example, this may allow the content provider 238 to provide continuity across the instances of engagement (e.g. maintaining a login or a shopping cart across the instances of engagement), and/or to provide accurate analytics such as how many unique users have engaged with the content provider 238 or how each user interacts with the content provider 238. Other advantages are described below.

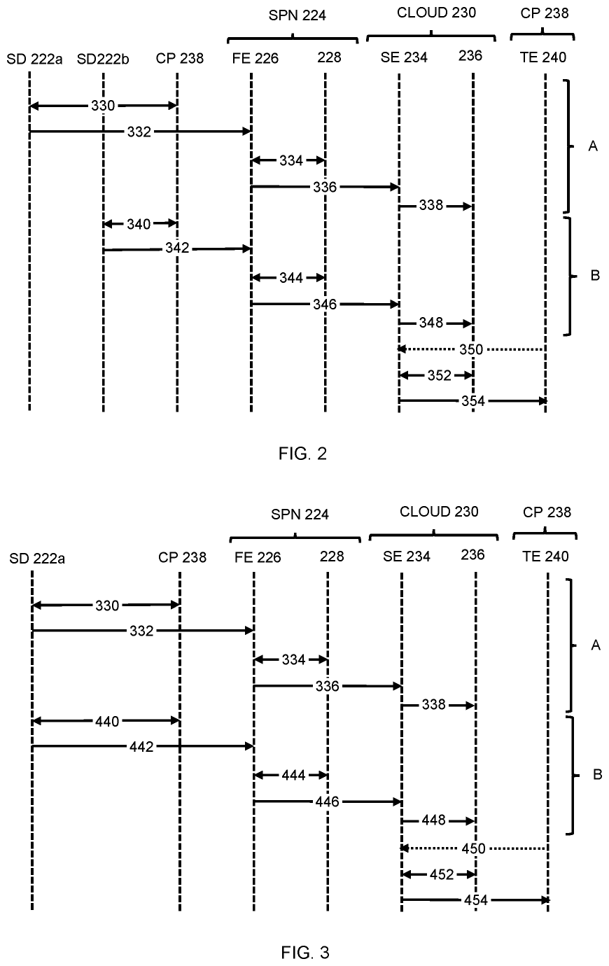

Referring to FIGS. 2 and 3, there are illustrated signalling diagrams showing signalling between the components of the network 200 according to examples. In each case, the signalling allows the content provider 238 to associate different instances of engagement of the subscriber of the service provider network 224 with the content provider 238. In both FIGS. 2 and 3, signalling that occurs for a first instance of engagement of the subscriber of the service provider network 224 with the content provider 238 are indicated with the label ‘A’, and signalling that occurs for a second, different, instance of engagement of the subscriber of the service provider network 224 with the content provider 238 are indicated with the label ‘B’. FIG. 2 illustrates an example where the first instance A is with a first subscriber device 222a and the second instance B is with a second, different, subscriber device 222b. FIG. 3 illustrates an example where the first instance A is with the first subscriber device 222a at a first time, and the second instance B is also be with the first subscriber device 222a but at a later time.

Referring first to FIG. 2, the first subscriber device 222a and the content provider 238 exchange one or more requests and responses 330 so that the content provider 238 provides content to the first subscriber device 222a. For example, the first subscriber device 222a may request content from the content provider 238 and the content provider may respond with the content to the first subscriber device 222a. As described above, these requests/responses 330 may be routed by the service provider network 224. However, these requests/responses may be encrypted between the first subscriber device 222a and the content provider 238, e.g. according to HTTPS protocols, and hence the service provider network 224 may not be able to read the encrypted content of the requests/responses 330.

The provision 330 of content by the content provider to the first subscriber device 222a is associated with a first identifier (ID). For example, the first ID may be a Universally Unique ID, e.g. a 128 bit string which may be randomly generated and hence, for practical purposes, is unique. For example, the first ID may have the format “\hat{ }[0-9a-f] {8} \b-[0-9a-f]{4}\b-[0-9a-f] {4}\b-[0-9a-f] {4}\b-[0-9a-f] {12}$”, where “0-9a-f” indicates the characters may be a number from 1 to 9 or a letter from a to f, and the number in curly brackets indicates the number of characters in a particular section. An example of a UUID which may be randomly generated as a first ID is “2278de4c-d790-4beb-9b12-4721090f18f6”.

The first ID may be generated when the first subscriber device 222a obtains the content from the content provider 238. For example, the first ID may be generated by the content provider 238 and provided to the first subscriber device 222a when the content is provided to the subscriber device 222a. The first ID may be included into the response that includes the content. For example, the first ID may be set or stored as a cookie on the first subscriber device 222a (e.g. on a browser of the first subscriber device 222a) by the content provider 238 when the content provider 238 provides the content. As another example, the content provided to the first subscriber device 222a by the content provider 238 may include code (or a link to code which may be subsequently fetched by the subscriber device 222a) which causes the first subscriber device 222a to generate the first ID and transmit it to the content provider 238. In either case, the first ID is available at both the content provider 238 and the first subscriber device 222a. The content provider 238 may store the first ID in association with information about this first instance of engagement with the content provider 238, for example browsing attributes such as characteristics of the content provided and/or the interaction of the subscriber with the content, and/or continuity information such as a language preference or contents of a shopping cart established by the subscriber, or the like.

The first subscriber device 222a transmits a first message 332 including the first ID to the first entity 224 of the service provider network 224. For example, the content provided to the first subscriber device 222a by the content provider 238 (i.e. the content obtained by the first subscriber device 222a from the first content provider 238) may comprise code (or a link to code which may be subsequently fetched by the subscriber device 222a) that causes the first subscriber device 222a to send the first message to the first entity 224. In some examples, the first message may be a HTTPS GET request including the first ID as a query parameter. In some examples, the first message 332 may be a ‘sync’ request, i.e. a synchronisation request to request synchronising of the processing of requests by the service provider network 224. The first message 332 may be encrypted between the first subscriber device 222a and the service provider network 238, and the service provider network may decrypt the first message 332 in order to obtain the first ID. In any case, the service provider network 238 obtains the first ID from the first message 332.

The first entity 226 at the service provider network 224 identifies the subscriber based on the received first message 332. For example, identifying the subscriber based on the received message 332 may comprise determining a first subscriber identifier for the subscriber that identifies the subscriber within the service provider network 224. The first entity 226 may identify the subscriber by accessing 334 the storage 228 at the service provider network 238. For example, the storage 228 may store associations between the first subscriber identifier and e.g. an IP address or range of IP addresses for which the service provider network 238 provides services to the subscriber and/or e.g. an International Mobile Equipment Identity (IMEI) or International Mobile Subscriber Identity (IMSI) of each of the subscriber devices 222a, 222b for which the service provider network 238 provides services to the subscriber. The first message 332 may include (e.g. in a header of the HTTPS request 332) e.g. the source IP address from which the first message 332 is transmitted and/or e.g. the IMEI or IMSI for the subscriber device 222a from which the first message is transmitted. The first entity 226 may use this information to look-up in the storage 228 the first subscriber identifier and thereby identify the subscriber. Other known methods by which a service provider network 224 identifies a subscriber (e.g. determines the first subscriber identifier) from a message sent from a subscriber device 222a, 222b may be used.

The first entity 226 at the service provider network 224 determines an identifier for the subscriber based on the identification of the subscriber. In this example, the identifier for the subscriber may be a second subscriber identifier for the subscriber that identifies the subscriber at the second entity 234 in the cloud 230. For example, the first subscriber identifier that identifies the subscriber within the service provider network 224 may not be permitted to be transmitted outside of the service provider network 224. Accordingly, the second subscriber identifier for the subscriber (different from the first subscriber identifier) may be determined which is permitted to be transmitted outside the service provider network 224. For example, the first entity 226 may determine an identifier for the subscriber by deriving a second subscriber identifier based on the first subscriber identifier. The second subscriber identifier may uniquely identify the subscriber at the second entity 236. For example, the second subscriber identifier may be a UUID. The second subscriber identifier may be derived based on the first subscriber identifier. For example, where a second subscriber identifier for the subscriber is already stored in association with the first subscriber identifier at the first entity 226 (e.g. at the storage 228 associated therewith), deriving the second subscriber identifier may comprise using the first subscriber identifier to look up the second subscriber identifier. Where no second subscriber identifier for the subscriber is already stored in association with the first subscriber identifier at the first entity 226 (e.g. at the storage 23228 associated therewith), deriving the second subscriber identifier may comprise generating the second subscriber identifier for the first subscriber identifier. In this case, the generated second subscriber identifier may be stored in association with the first subscriber identifier at the first entity 226 (e.g. at the storage 228 associated therewith).

The determined identifier for the subscriber and the first ID are transmitted 336 from the first entity 226 to the second entity 234. Specifically, in this example, the second subscriber identifier and the first ID are transmitted 336 from the first entity 226 in the service provider network 224 to the second entity 234 in the cloud 230. For example, the first entity 224 may be configured to modify the first message 332 (which already includes the first ID) to also include the second subscriber identifier, and send the modified first message 336 to the second entity 234. For example, the first message 332 may be a HTTP request, and the first entity 224 may modify the HTTP request by inserting the second subscriber identifier into the header of the HTTP request.

The second entity 234 stores 338 the first ID in association with the determined identifier for the subscriber, for example in the storage 236 in the cloud. For example, the second entity 234 may receive the modified first message 336, extract the second subscriber identifier and the first ID from the modified first message 336, and store 338 the first ID in association with the second subscriber identifier, for example in the storage 236.

In any case, the second entity 234 stores 338 the first ID in association with the determined identifier for the subscriber, for example in the storage 236 in the cloud 230. This completes the signalling for the first instance A of user engagement with the content provider 238. At this stage, the content provider 238 has knowledge of the association of the first ID with the first instance A of subscriber engagement with the content provider 238, and the second entity has knowledge of the association of the first ID with the subscriber identified by the service provider network 224.

For the second instance B of subscriber engagement with the content provider 238, in this example the subscriber uses a different subscriber device 222b, but otherwise the signalling 340-348 is similar to the signalling 330-338 of the first instance A.

Specifically, in the second instance B, the second subscriber device 222b and the content provider 238 communicate 340 so that the second subscriber device 222b is provided with content by the content provider 238. A second ID is associated with the provision of the content from the content provider 238 to the second subscriber device 222b in the second instance B. The second ID is different to the first ID, but may be in the same format as the first ID, e.g. a randomly generated UUID as described above. The second ID may be generated in a similar way to the first ID as described above. For example, the second ID may be generated when the second subscriber device 222b obtains the content from the content provider 238 in the second instance. For example, the second ID may be generated by the content provider 238 and provided to the second subscriber device 222b when the subscriber device 222b obtains the content from the content provider 238. The second ID may be stored as a cookie on the second subscriber device 222b by the content provider 238. In any case, the content provider 238 may store an association of the second ID with the second instance of engagement with the content provider (e.g. store the second ID in association with a set of browsing attributes of the subscriber's engagement with the content provider in the second instance B).

The second subscriber device 222b sends a second message 342 including the second ID to the first entity 226 in the service provider network 238. Similarly to as mentioned for the first instance A, the content obtained by the second subscriber device 222b in instance B may contain code (or a link to code) that causes the second subscriber device 222b to send the second message 342 to the first entity 226. For example, the second message 342 may be a HTTPS GET request, e.g. a sync request, similar to that as described above for the first message 332.

The first entity 226 identifies the subscriber based on the second message 342. For example, similarly to as escribed for the first instance A, in the second instance may identifying the subscriber based on the second message may comprise determining the first subscriber identifier for the subscriber (for example based on the source IP address or IMEI or IMSI or other information included in the second message) by accessing 344 the storage 228 and looking up the first subscriber identifier in the storage 228.

The first entity 226 determines the identifier for the subscriber based on the identification of the subscriber. For example, the first entity 226 may use the first subscriber identifier to look up the second subscriber identifier in the storage 228 (which may already store the second subscriber identifier in association first subscriber identifier, as a result of processing the first message 332 in examples).

The first entity 226 transmits 346 the second ID and the identifier for the subscriber (e.g. the second subscriber identifier) to the second entity 234 of the cloud 230. For example, the first entity 226 may be configured to modify the second message 342 to include the second subscriber identifier and send the modified second message 346 to the second entity 234.

The second entity 234 stores 348 (e.g. in the storage 236) the second ID in association with the identifier for the subscriber, and thereby in association with the first ID.

In any case, the second entity 236 stores 348 the second ID in association with the determined identifier for the subscriber, for example in the storage 236 in the cloud 230, and thereby in association with the first ID. This completes the signalling for the second instance B of user engagement with the content provider 238. At this stage, the content provider 238 has knowledge of the association of the first ID with the first instance A of subscriber engagement, and the association of the second ID with the second instance B of subscriber engagement, but does not know that the first instance A and the second instance B are by the same subscriber. However, the second entity 234 has knowledge of the association of the first ID and the second ID with the identifier for the subscriber (e.g. the second identifier for the subscriber), and hence that first ID and the second ID are associated with the same subscriber of the service provider network 224.

The second entity 234 provides 354, to the third entity 240 associated with the content provider 238, information indicating the stored association between the second ID and the first ID. This allows the third entity 240 to associate the first instance A with the second instance B.

In some examples, the second entity 234 may provide this association information autonomously, for example in response to the second ID being stored in association with the first ID. In some examples, the second entity 234 may provide the association information at intervals, for example regular intervals. In some examples, the third entity 240 may request 350 the second entity 234 to provide the association information. For example, the third entity 240 may request all of the association information stored. As anther example, the third entity 240 may provide the second ID to the second entity 234 and request information on whether this second ID is association with any other stored ID, for example the first ID from the first instance A. The second entity 234 may look up 352 stored associations in the storage 236, and generate and provide the information indicating the stored association between the second ID and the first ID, to the third entity 240.

In any case, the second entity 234 provides 354, to the third entity 240 associated with the content provider 238, the information indicating the stored association between the second ID and the first ID. The content provider 238 now has knowledge of the association of the first ID with the first instance A of subscriber engagement, the association of the second ID with the second instance B of subscriber engagement, and also the association of the first ID and the second ID. The content provider 238 may therefore associate the first instance A of user engagement with the second instance of B of user engagement. For example, the content provider 238 may determine that the first instance A and the second instance B are from the same user. Note however, that the content provider 238 is not provided with any information that identifies the subscriber to the content provider 238, and the content provider 238 does not know the identity of the subscriber 238. The content provider can therefore determine that the two instances A and B were from the same subscriber, but not the identity of that subscriber.

The content provider 238 associating the first A and second B instances of engagement of a subscriber may, in turn, allow a website provided by the content provider 238 to work more efficiently. For example, this may allow the content provider 238 to provide continuity across the instances of engagement (e.g. maintaining a login or a shopping cart across the instances of engagement), and/or to provide accurate analytics such as how many unique users have engaged with the content provider 238 or how each user interacts with the content provider 238. It is noted that this is provided for even though the different instances of engagement of the subscriber with the content provider 238 use different subscriber devices 222a, 222b.

Referring to FIG. 3, there illustrated signalling of components of the telecommunications network 220 in the case where the first instance A and the second instance B are with the same subscriber device 222a.

In the example of FIG. 3, the signalling 330-338 in the first instance A is the same as described above for FIG. 2 and so will not be described again.

In the example of FIG. 3, the signalling 440-454 in the second instance B is similar to the signalling 340-354 in the second instance B described above for FIG. 2, except that in FIG. 3, the engagement in the second instance B is with the first subscriber device 222a.

Specifically, referring to FIG. 3, in the second instance B, the first subscriber device 222a and the content provider 238 communicate 440 in such a way that content is provided to the first subscriber device 222a by the content provider 238. The provision of content 440 in the second instance B is associated with a second ID, different to the first ID. For example, the content provider 238 may generate the second ID when the subscriber device 222a requests content in the second instance, and the content provider 238 may set a cookie including the second ID on the first subscriber device 222a. This may occur, for example, where the cookie including the first ID set on the first subscriber device 222a by the content provider 238 in the first instance A has expired, or has been deleted by the browser of the first subscriber device 222a, or is otherwise not available on the first subscriber device 222a in the second instance. For example, the browser may delete the cookie including the first ID once a session is closed or after a certain time, or the cookie itself may expire after a certain time, for example may be required to expire after a certain time. In this case, the content provider 238 will not be provided with the cookie including the first ID when the subscriber device 222a requests content in the second instance, and so generates the second ID and sets a cookie on the first subscriber device 222a including the second ID.

In a similar way as described above for the signalling 330-338 in the first instance A, in the second instance B, the first subscriber device 222a sends the second ID in a second message 442 to the first entity 226. The first entity 226 identifies 444 the subscriber based on the second message 442, determines an identifier (e.g. the second identifier) for the subscriber based on the identification of the subscriber, and transmits the identifier for the subscriber and the second ID to the second entity 234. For example, the first entity 226 may send a modified version 446 of the second message 442 that includes the second ID and the second subscriber identifier). The second entity 234 stores 448 the second ID in association with the identifier for the subscriber, and thereby in association with the first ID.

The second entity 234 provides 454, to the third entity 240 associated with the content provider 238, information indicating the stored association between the second ID and the first ID, thereby to allow the third entity 240 to associate the first instance A with the second instance B. For example, the information may be provided in response to a request 450 from the third entity 240 for the association information and the second entity 234 obtaining 452 the association information from the storage 236.

The content provider 238 may therefore associate the first instance A of user engagement with the second instance of B of user engagement. This may provide for the advantages mentioned above. It is noted that this is provided for even though the different instances of engagement of the subscriber with the content provider 238 are at different times.

In the above examples described with reference to FIGS. 1 to 3, the second entity 234 is in the cloud 230 and is external to the service provider network 224. However, this need not necessarily be the case and in other examples (not shown) the second entity 234 may be part of the service provider network 224. For example, the first entity 226 and the second entity 234 may both be part of the service provider network 224, and may for example be implemented as parts of the same device or group of devices within the service provider network 224, for example as functional units of a server within the service provider network 224. In these cases, the identifier for the subscriber may be the second subscriber identifier, or in some cases may be the first subscriber identifier. For example, the first entity 226 may identify the subscriber, determine the first identifier for the subscriber, and pass this to the second entity 234 (along with the first ID or second ID as described above). The second entity 234, in these cases where the second entity 234 is within the service provider network 224, may then use the first subscriber identifier as the identifier for the subscriber. In either case, in these examples, the second entity 234 may store the first ID and the second ID in association with the determined identifier for the subscriber, e.g. within the service provider network 224. The second entity 234 may then provide the information on the association of the first ID and second ID to the content provider 238. Nonetheless, it is noted that the second entity 234 being external to the service provider network 224, as per the examples described above with reference to FIGS. 1 to 3, may provide for the method to be extended to multiple service provider networks. For example, rather than just one service provider network 224 as in FIG. 1 there may be multiple service provider networks 224 (not shown), and the method described above may be applied equally for subscribers of each of the multiple service provider networks.

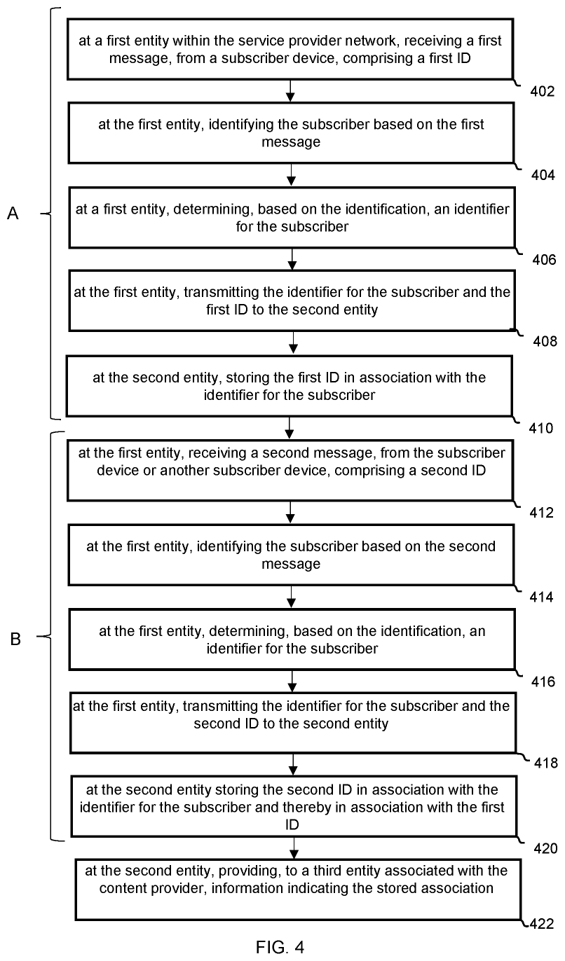

According to the above, and as illustrated by the flow diagram in FIG. 4, there is provided a method for associating different instances A, B of engagement of a subscriber of a service provider network 224 with a content provider 238.

For a first instance A, the method comprises, at a first entity 226 within the service provider network 224: in step 402, receiving a first message 332 from a subscriber device 222a of the subscriber, the first message 332 comprising a first ID associated with the provision 330 of content from the content provider 238 to the subscriber device 222a in the first instance A; and in step 404 identifying the subscriber based on the received first message 332. For example, the first entity 226 may identify the subscriber based on the received first message 332 by any of the example methods described above. The method further comprises, at the first entity 226, in step 406, determining an identifier for the subscriber based on the identification of the subscriber. The method further comprises, at the first entity 226, in step 408, transmitting the identifier for the subscriber and the first ID to a second entity 234.

For the first instance A, the method further comprises, at a second entity 234: in step 410, storing 228 the first ID in association with the identifier for the subscriber. For example, the identifier for the subscriber may be the first subscriber identifier (e.g. in cases where the second entity 234 is within the service provider network 224) or the second subscriber identifier (e.g. in cases where the second entity 234 is external to the service provider network 224) determined as described above.

For a second instance B, the method comprises, at the first entity 226: in step 412, receiving a second message 342, 442 from the subscriber device 222a or another subscriber device 222b of the subscriber, the second message 342, 442 comprising a second ID different to the first ID, the second ID being associated with the provision 330, 440 of content from the content provider 238 to the subscriber device 222a or the other subscriber device 222b in the second instance B; and in step 414, identifying the subscriber based on the received second message 342, 442. For example, the first entity 226 may identify the subscriber based on the received second message 342, 442 by any of the example methods described above. The method further comprises, in step 416, at the first entity 226, determining the identifier for the subscriber based on the identification of the subscriber. The method further comprises, in step 418, at the first entity, transmitting the identifier for the subscriber and the second ID to the second entity 234.

For the second instance B, the method further comprises, at the second entity 234: in step 420, storing 348, 448 the second ID in association with the identifier for the subscriber and thereby in association with the first ID.

The method further comprises, at the second entity: in step 422, providing, to a third entity 240 associated with the content provider 238, information indicating the stored association between the second ID and the first ID, thereby to allow the third entity 240 to associate the first instance A with the second instance B.

In some examples, the method may further comprise the third entity 240 associating the first instance A with the second instance B based on the information indicating the association between the second ID and the first ID.

In some examples, the method may further comprise the third entity 240 modifying content to be provided by the content provider 238 to the subscriber device 222a or the other subscriber device 222b in the second instance B based on the determined association with the first instance A. For example, the third entity may modify the content to provide continuity with the first instance A, such as maintaining a user login, language preference, and/or or items in a shopping basket or the like. In some examples, the method may comprise providing the modified content to the subscriber device 222a or the other subscriber device 222b in the second instance B. This may provide for a website provided by the content provider 238 to work more efficiently, for example allow for an efficient user interaction with the content provided over different instances.

In some examples, the method may comprise the third entity 240, based on the determined association of the first instance A with the second instance B, storing information about the first instance A with information about the second instance B, for example merging information about the first instance A with information about the second instance B. For example, this may more accurately reflect the number of unique users that have engaged with the content provider. In some examples, the information about the instance may comprise, for each instance A, B, browsing attributes such as characteristics of the content provided and/or the interaction of the subscriber with the content, and/or continuity information such as a language preference or contents of a shopping cart established by the subscriber, or the like. This may allow the content provider to produce more accurate analytics on the interaction of users with the content provider 238.

In the examples described above with reference to FIGS. 1 to 3, there is only one content provider 238. However, it will be appreciated the method may be applied for multiple content providers (not shown). To facilitate this, in some examples, the first message 332 and the second message 342, 442 may each further include a third ID identifying the content provider from which the content is provided. The method may comprise, for the first instance A and the second instance B, at the second entity 234, storing the third ID in association with the first ID and the second ID respectively.

In some examples, the third ID may be a three-letter code (e.g. ‘AAA’) uniquely identifying the content provider 238 among other content providers that the second entity 234 is configured to provide association information to. In some examples, the third ID may be any format, and may letters and/or numbers. The third ID may be included in the cookies set by the content provider 238 in the first and second instances A, B. The code (or a link to code) included in the content may cause the first and second subscriber devices 222a, 222b to include into the first and second messages 332, 342, 442 respectively the third ID. This third ID may be passed on to the second entity 234 in the same example ways as described above for the first ID and the second ID. The second entity 234 may then store the third ID in association with the first ID and the second ID respectively.

In these examples, the provision, by the second entity 234, of the information indicating the association between the second ID and the first ID to the third entity 240 may be responsive to a determination that the first ID and the second ID are stored in association with the third ID. For example, the second entity 234 may only send association information to a content provider 238 for first and second IDs that are stored in association with the third ID that identifies that content provider 238. This may help ensure that only the content provider 238 that the subscriber has engaged with in the relevant instances A, B is provided with the association information.

In some examples, the methods may be implemented in environments where subscriber consent may be needed in relation to processing of data relating to individuals. For example, in some implementation environments, there may exist a requirement that the subscriber consents to the use of their identification by the service provider network 224, in order to provide the functionality to associate different instances of engagement of the subscriber with the content provider, as described above.

In order to implement such a consent mechanism, in some examples, the first message 332 and the second message 342, 442 may include consent information associated with the first ID and the second ID, respectively. The consent information for the first ID and the second ID may indicate whether or not the subscriber consents to the use of their identification by the service provider network 224 for the first ID and the second ID, respectively. In these examples, the method may comprise, for both the first and second instance A, B: at the second entity 234, storing the consent information for the first ID in association with the first ID and storing the consent information for the second ID in association with the second ID, respectively.

The consent information may be, for example, in the form of a consent flag or other marker in the first/second message 332, 342, 442. In some examples, the consent information may comprise one or more bits indicating whether or not the user has provided the consent for the first/second ID with which it is associated. In some example, the consent information may comprise a consent expiry. For example, the consent information for the first ID may comprise a consent expiry for the first ID and the consent information for the second ID may comprise a consent expiry for the second ID. For example, in cases where the subscriber has provided consent, the consent expiry may be set to a suitable, for example predetermined, future time (e.g. 1 day in the future), and in cases where the subscriber has not provided consent, the consent expiry may be set to zero. For example, where the user has provided consent the consent expiry may be in the form of a Unix timestamp, in the unit of seconds since epoch, and where the user has not provided consent the consent expiry may be set to zero (0).

The consent information may be determined, for example, based on the response of a subscriber to a dialogue box or a pop-up window presented to the subscriber when the subscriber device 222a, 222b processes the content received from the content provider 238. For example, the content provided to the subscriber device 222a, 222b may include code (or a link to code) that causes the subscriber device 222a, 222b (e.g. a browser thereof) to present the dialogue box or a pop-up window to obtain the subscribers consent. The consent information may be stored in the cookie set by the content provider 238 on the subscriber device 222a, 222b. The code may cause the subscriber device 222a, 222b to include the consent information associated with the first ID and second ID into the first message 332 and the second message 342, 442, respectively. The consent information may be passed on to the second entity 234 in the same example ways as described above for the first ID and the second ID. The second entity 234 may then store the consent information for the first ID and the second ID in association with the first ID and the second ID, respectively.

In these examples, the provision the information indicating the association between the second ID and the first ID to the third entity 240 may be responsive to a determination, based on the stored consent information for the first ID and the second ID, that there is a valid consent for the use of the identification of the subscriber by the service provider network 224 for the first ID and the second ID. For example, the determination that there is a valid consent may comprise determining whether or not the stored consent for the first ID and second ID has expired. In some examples, in cases where the stored consent has not expired the association information may be provided, whereas if the stored consent has expired then the association information may not be provided. This may help provide that the result of the identification of the subscriber by the service provider network 224 is only used by the second entity 234 when valid consent exists for that use.

In some examples, determining whether the consent has expired may comprise comparing the stored consent expiry to a current time. For example, the consent information for the first ID may comprise a consent expiry for the first ID and the consent information for the second ID may comprise a consent expiry for the second ID, and determining that there is a valid consent for the first ID and the second ID may be based on a comparison of the stored consent expiry for the first ID and the second ID with a current time. For example, if the consent expiry is in the future as compared to the current time then it may be determined that the consent has not yet expired, and if the consent expiry is in the past as compared to the current time then it may be determined that the consent has expired.

In some examples, the subscriber may renew or revoke the consent in subsequent instances of engagement. In order to implement this, in some examples, the consent information stored at the second entity 234 associated with the first ID (as included in the first message 332) may be updated based on the consent information associated with the second ID (as included in the second message 342, 442). For example, the method may comprise updating the stored consent expiry associated with the first ID based on the consent information associated with the second ID included in the second message 342, 442.

The subscriber may provide consent for the use of both the first ID and the second ID. In these examples, updating the stored consent information for the first ID may be based on whether or not the consent for the first ID has expired when the consent information for the second ID is received. For example, if, when the second ID (and its associated consent information) is received at the second entity 234, the stored consent for the first ID has not yet expired, then the second entity 234 may update the consent expiry for the first ID to be the same as that provided for the second ID. This may help implement a renewal of the subscriber's consent for the identification by the service provider network 224 for the purposes of associating instances of engagement with the particular content provider 238.

In some examples, if, when the second ID (and its associated consent information) is received at the second entity 234, the stored consent for the first ID has expired, then the second entity 234 may simply store the second ID and its associated consent expiry, without changing the consent expiry for the first ID. This may help implement consent expiry requirements.

As another example, the subscriber may provide consent for the use of the first ID, but not for the second ID. For example, the user may provide consent for the first ID and hence the first message 332 may include the first ID and a consent expiry set to a future time (e.g. 1 day). However, the user may not provide consent for the second ID and hence the second message 342, 442 may include the second ID and a consent expiry set to zero. On receiving the second ID with the consent expiry set to zero, the second entity 234 may set the consent expiry stored for the first ID and the consent expiry for the second ID to the current time. Accordingly, in these examples, the first ID and the second ID will not be used in the provision of association information to the third entity 240. This may help implement consent requirements.

In some examples, the stored consent associated with the first ID and/or the second ID and may be updated by the second entity 234 by means of receipt of other messages. For example, in a third instance (not shown) of engagement of the subscriber with the content provider 238, the subscriber client device 222a, 222b may send a third message comprising the first ID and updated consent information associated with the first ID or the second ID and updated consent information associated with the second ID. In these examples, the method may comprise, at the second entity 234, updating the stored consent information for the first ID or for the second ID based on the updated consent information associated with the first ID and/or the second ID, respectively. For example, the updated consent information may comprise a consent expiry set to zero, indicating that the user no longer consents. In this case, the stored consent expiry for both the first ID and the second ID may be updated by the second entity 234 to a current time. As another example, the third message may include the first ID (or the second ID) and a renewed consent for the first ID (or second ID), i.e. a consent with a later expiry than is already stored for the first ID (or second ID). In this case, the stored consent expiry for the first ID (or second ID) may be updated and extended accordingly.

In some examples, the third message (not shown) may be similar to the first message 332 or the second message 342, 442 in that it is sent by the subscriber device 222a, 222b to the first entity 226 within the service provider network 224 which then modifies the third message and sends the modified third message to the second entity 234 in the cloud 230. However, in other examples, the third message (not shown) may be received by the second entity 234 from a subscriber device 222a, 222b via a network (e.g. an access network) other than the service provider network 224 and without passing through the service provider network 224. For example, in the third instance, the subscriber may be engaging with the content provider 238 with a subscriber device 222a, 222b which is not connected via the service provider network 224 (e.g. mobile network) to the Internet 229 and content provider 238, but rather via another network (not shown, e.g. public wifi). For example, the content obtained by the subscriber device 222a, 222b in the third instance may include code (or link to code) that causes the subscriber device 222a, 222b to send the third message including the first ID (or second ID) and the updated consent information for the first ID (or for the second ID, e.g. set to zero) to the second entity 234 in the cloud 230. In this case, since the subscriber device 222a, 222b is connected to the other network (not shown), the third message will be sent via the other network (not shown). For example, a Domain Name System (DNS, not shown) of the other network (not shown) may resolve a domain in the third message (e.g. a domain specified in a GET request constituting the third message) to a server in the cloud 230, for example the second entity 234, and accordingly the third message (not shown) may be routed by the other network (not shown) to the second entity 234 in the cloud 230. The second entity 234 may determine that the first ID (or second ID) provided in the third message is stored at the second entity, and update the consent information associated with that stored first ID (or second ID) according to the updated consent information. This may help implement consent requirements, and in particular providing for the renewal or revocation of the consent for the use of the first ID or second ID, even when the subscriber device 222a, 222b is not connected to the service provider network 224.

In other examples, if the user does not provide consent for a particular ID (e.g. the second ID), the associated message (e.g. the second message 342, 442) may not be sent by the subscriber device 222a, 222b. In this case, the association between the first ID and the second ID will not be made at the second entity 234, because the second ID will not be available to the second entity 234. This may help implement the case of where consent is not provided, in a resource efficient manner.

In some examples, the first message 332 and/or the second message 342, 442 may include one or more fourth IDs each providing an alternative identifier for the subscriber by which the subscriber may be known to the content provider 238. The fourth ID may take any format. The second entity 234 may store the fourth ID in association with the determined identifier for the subscriber (e.g. the second subscriber identifier as described above). The fourth ID may be associated with a consent expiry and this may be stored in association with the fourth ID by the second entity 234. In some examples, the fourth ID may be associated with its own consent expiry. In examples where the fourth ID is not provided in association with a consent expiry, the consent expiry of the first ID (or the second ID) with which the fourth ID is provided may be used instead. The association information provided to the content provider 238 by the second entity may include the fourth ID(s) that are stored in association with the first ID and/or the second ID. This may provide the content provider 238 with further information by which analytics can be performed.

In examples where the fourth ID is already stored in association with the identifier for the subscriber (e.g. second subscriber identifier), then the stored consent expiry may be updated by the consent expiry associated with the fourth ID included in the first message 332 or the second message 342, 442. In examples where the fourth ID is already stored, but in association with a different second subscriber identifier than that determined for the first message 332 or the second message 342, 442, then the fourth ID and the consent expiry is stored in association with the second subscriber identifier determined for the first message 332 or the second message 342, 442, and the consent expiry for the fourth ID stored in association with the different subscriber identifier is updated.

According to the above examples, consent may be set, renewed or revoked by a given subscriber on a per content provider 238 basis. This may provide for a more flexible implementation of consent requirements, for example as compared to managing consent on a per subscriber basis only.

According to the above, in some examples, the first message 332 and the second message 342, 442 may each be implemented by GET requests for example having the form “https://<domain>/partner?partid=<partid>&brandid=<brandid>&consent=<consent>&altids=<altids>”. The “domain” is the address to which the GET request is sent. The “partid” is the first ID (or the second ID) with which the particular instance of user engagement is associated, which may have a UUID format. The “brandid” is the third ID identifying the content provider 238, which may be a three-character string. The “consent” is the consent information associated with the first ID (or second ID), which may take the form of a consent expiry in units of seconds since unix epoch. The optional “altids” are the fourth IDs by which the subscriber may be alternatively known to the content provider 238. These may be provided as a coma separated list of IDs, and their associated consent information (if it exists) separated by a colon. An example of such a GET request is “https://ntidsync.com/partner?partid=2278de4c-d790-4beb-9b12-4721090f18f6&brandid=123&consent=1612949292&altids=123 e4567-e89b-12d3-a456-426655440000:1612949999,C73BCDCC-2669-4Bf6-81d3-E4AE73FB11FD”.

In some examples, the parameters of the first message 332 and the second message 342, 442 may be validated, for example by the second entity 236, before they are used further. For example, it may be checked that one or more of the first ID (or second ID), the consent information, the third ID are present and in the correct format. In addition, for example, it may be checked that the third ID is a known value. If the parameters are validated, then the second entity 236 may store the parameters as described above. However, if the parameters are not validated, the second entity 236 may not store the parameters. This may help to implement data privacy as it will avoid the storage of information included in the first message 332 and the second message 342, 442 that was not expected to be included into those messages.

In some of the above examples, the first ID and the second ID are stored as cookies on the subscriber device 222a, 222b, but may be associated with a consent expiry. This may provide that the first ID and/or the second ID are semi-persistent. This may help provide that, where transactions between the subscriber and the content provider 238 are on the same subscriber device 222a, 222b and within the consent expiry of the first ID (or second ID), the content provider 238 can analyse the subscribers engagement based on the same ID (e.g. first ID). This may be more efficient as compared to e.g. generating a new ID for each subscriber device/content provider transaction. However, the first ID and the second ID being semi persistent (i.e. expiring after a certain time) may help prevent third parties (e.g. malicious third parties, e.g. via a ‘man-in-the-middle’ attack) from building up a profile of the subscriber based on the first ID or the second ID.

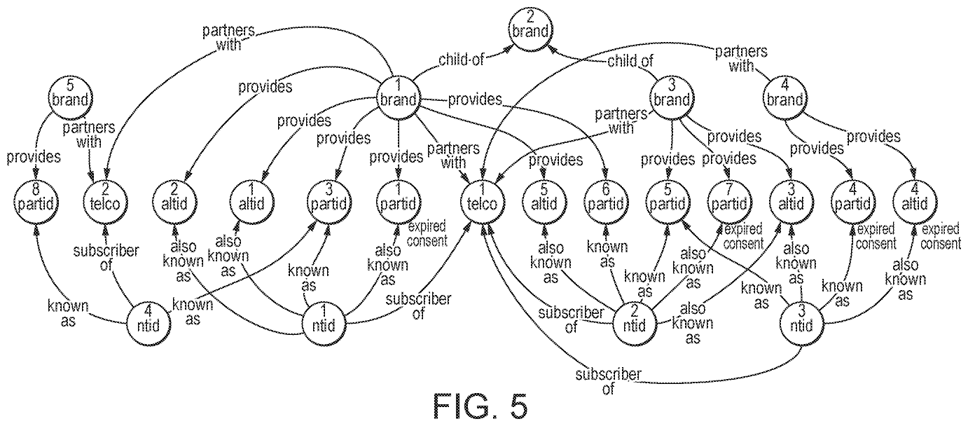

In some examples, the pieces of data which are stored in association with each other at the second entity 234 (i.e. in the storage 236 associated with the second entity 234) are stored in the form of a graph. Referring to FIG. 5, there is illustrated a graph according to which data may be stored at the second entity 234 (i.e. in storage 236 in the cloud 230) according to an example. In the example of FIG. 5, the nodes of the graph (represented by circles) represent pieces of stored information, and the edges (represented by arrows) represent logical links or associations between the pieces of stored information. The graph may be implemented, for example, by a Graph Database.

In the example of FIG. 5, there are a total of four subscribers represented. These subscribers are represented by four different second subscriber identifiers ‘1ntid’, ‘2ntid’, ‘3ntid’ and ‘4ntid’ (i.e. the identifiers by which the subscribers are identified at the second entity 234). The four subscribers are subscribers of two service provider networks, represented by ‘1teloc’ and ‘2telco’. (The service provider network may be determined by the second entity 234, for example, from the messages 336, 346, 446 sent to the second entity 234 by the first entity 226 in the service provider network 224, for example from a field in the message indicating the sender of the message). In the example of FIG. 5 there are five content providers represented by third IDs ‘1brand’, ‘2brand’, ‘3brand’, ‘4brand’, ‘5brand’. The content providers ‘1brand’ and ‘3brand’ are ‘children’ of ‘2brand’ in the sense that the content provider ‘brand2’ provides or is in control of both the content providers ‘1brand’ and ‘3 brand’. In association with the subscribers and the content providers, there are eight first IDs (or second IDs) represented by ‘1partid’, ‘2partid’, ‘4partid’, ‘5partid’, ‘6partid’, ‘7partid’ and ‘8partid’. For example, these are first IDs or second IDs provided by the content provider when a subscriber engages with the content provider in a particular instance. Where consent has expired for a first ID, the graph notes ‘expired consent’. This is the case for example for first IDs ‘1partid’ and ‘7partid’. The most recent first ID or second ID for the subscriber and content provider network combination is represented by the edge label ‘known as’ whereas past combinations are represented by the edge label ‘also known as’. In association with the subscribers and the content providers, there are also five fourth IDs represented by ‘1 altid’, ‘2altid’, ‘4altid’ and ‘5altid’. These are the alternative identifiers provided by the content provider by which the content provider may otherwise know the subscriber. This is represented on the graph by the edge between each second subscriber identifier and each fourth ID stating ‘also known as’.

Where more than one different second subscriber identifiers for different service provider networks are associated with a common first ID or second ID (as is the case, for example with second subscriber identifiers ‘4ntid’ and ‘1ntid’ and the first ID ‘3partid’), it may be inferred by the second entity 234 that the different subscriber identifiers relate to the same subscriber, but using different service provider networks. For example, this may occur where a subscriber device 222a, 222b switches service provider networks during an instance of engagement with a content provider.

Where more than one different second subscriber identifiers for a common service provider networks are associated with a common first ID or second ID (as is the case, for example with second subscriber identifiers ‘2ntid’ and ‘3ntid’ and the first ID ‘5partid’), it may be inferred by the second entity 234 that the different subscriber identifiers relate to the same subscriber, but using different accounts within a service provider network. For example, this may occur where a subscriber device 222a, 222b switches from the device's own mobile data connection to a mobile (e.g. 4G) hotspot from the same service provider network during an instance of engagement with a content provider, or for example where the device has a dual SIM function where both the SIMS are from the same service provider network and the subscriber device 222a, 222b switches between SIMS during an instance of engagement with a content provider (or for example in any case where the same first ID or second ID is used, such as the same browser with the same cookie including the first ID or second ID).

Referring to FIG. 5, and taking the subscriber with second subscriber identifier ‘1ntid’ as an example, the subscriber is a subscriber of the service provider network ‘1telco’. The second subscriber identifier ‘1ntid’ is stored in association with the first ID ‘1partid’ (whose consent has expired), the second ID ‘3partid’, and the fourth IDs ‘1altid’ and ‘2altid’, all provided from the content provider ‘1brand’ (which happens to be a child of the content provider ‘2brand’). For example, where the content provider ‘1brand’ requests association information from the second entity 234, the second entity 234 may extract those IDs ‘1altid’, ‘2altid’, ‘3partid, ‘1partid’ that are stored in association with the subscriber ‘1ntid’ and which are stored in association with the content provider ‘1brand’, and provide information to the content provider ‘1brand’ that those IDs ‘1altid’, ‘2altid’, ‘3partid, ‘1partid’ are associated with one another (e.g. are associated with a single and common subscriber).

Storing the IDs in a graph in this way may provide an efficient way to store and maintain both the IDs and the associations between the IDs.

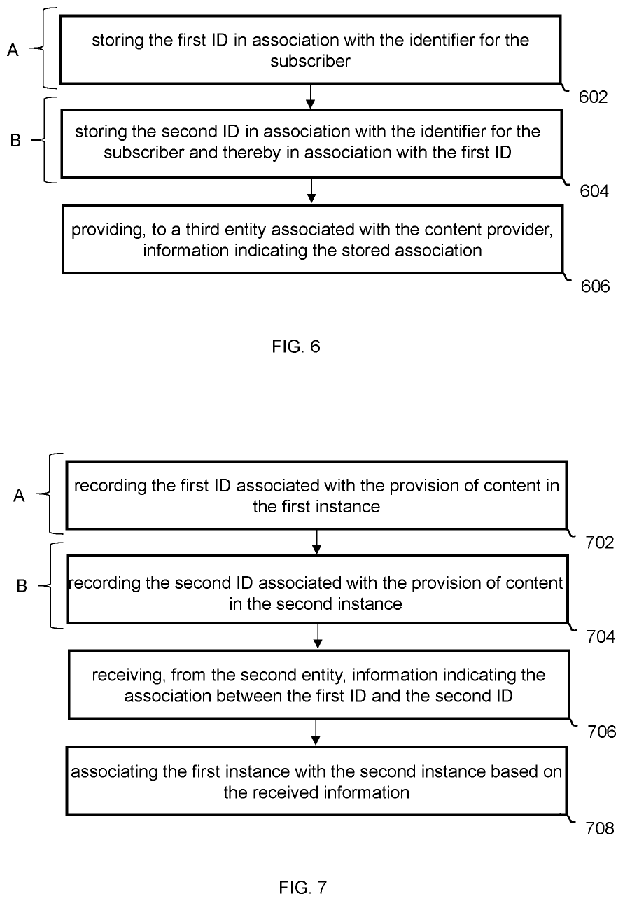

According to the above, specific methods may be performed at specific ones of the first entity 226, the second entity 234, and the third entity 240. To illustrate this, FIG. 6 shows a method performed at the second entity 234, and FIG. 7 shows a method performed at the third entity 240.

Referring to FIG. 6, the method at the second entity 234 comprises, for the first instance A: in step 602, storing the first ID in association with the identifier for the subscriber, the first ID having been included in a first message 332 received from a subscriber device 222a by the first entity 226 within the service provider network 224, the subscriber having been identified, by the first entity 226, based on the first message 332, the identifier for the subscriber having been determined, by the first entity 226, based on the identification of the subscriber, the first ID and the identifier for the subscriber having been transmitted by the first entity 226 to the second entity 234, the first ID being associated with the provision of content from the content provider 238 to the subscriber device 222a in the first instance A. The method at the second entity 234 comprises, for the second instance B, in step 604: storing the second ID in association with the identifier for the subscriber and thereby in association with the first ID, the second ID having been included in the second message 342, 442 received from the subscriber device 222a or another subscriber device 222b by the first entity 226, the subscriber having been identified, by the first entity 226, based on the second message 342, 442, the identifier for the subscriber having been determined, by the first entity, based on the identification of the subscriber, the second ID and the identifier for the subscriber having been transmitted by the first entity to the second entity, the second ID being associated with the provision of content from the content provider 238 to the subscriber device 222a or the other subscriber device 222b in the second instance B. The method at the second entity 234 comprises, in step 606: providing, to the third entity 240 associated with the content provider 238, information indicating the stored association between the second ID and the first ID, thereby to allow the third entity 240 to associate the first instance A with the second instance B.

Referring to FIG. 7, there is illustrated a method performed at the third entity 240 associated with the content provider 238. The method comprises, for the first instance A, in step 702: recording the first ID associated with the provision of content from the first content provider 238 to the subscriber device 222a in the first instance A. The method comprises, for the second instance B, in step 704: recording the second ID associated with the provision of content from the content provider 238 to the subscriber device 222a, 222b or another subscriber device in the second instance B. The method comprises, in step 706: receiving, from the second entity 234, information indicating an association between the first ID and the second ID, the first ID and the second ID having been stored by the second entity 234 in association with an identifier for the subscriber, the subscriber having been identified, by the first entity 226 within the service provider network 224, based on a first message 332, comprising the first ID, received from a subscriber device 222a and based on a second message 342, 442, comprising the second ID, received from the subscriber device 222a or another subscriber device 222b, the identifier for the subscriber having been determined, by the first entity, based on the identification of the subscriber, the first ID and the identifier for the subscriber having been transmitted from the first entity to the second entity, the second ID and the identifier for the subscriber having been transmitted from the first entity to the second entity. The method comprises, in step 708: associating the first instance A with the second instance A based on the received information indicating the association between the first ID and the second ID.

In some of the above examples, the first ID and the second ID are set or stored as cookies on the subscriber device 222a, 222b (e.g. on a browser of the subscriber device 222a, 222b). However, in other examples the first ID and/or the second ID may not, or may not only, be set or stored as cookies on the subscriber device 222a, 222b. For example, in some examples the first ID and/or the second ID may alternatively or additionally be stored in a local storage of the subscriber device 222a, 222b. In a similar way, in some examples, the third ID, fourth ID and/or the consent information may alternatively or additionally be stored in the local storage of the subscriber device 222a, 222b.

In some examples, the first ID and/or the second ID may each be used for only one session (which may involve one or multiple transactions) between the content provider 238 and the subscriber device 222a, 222b. In this regard, the first ID and/or the second ID may each be a ‘per session’ ID. For example, within a session in which the content is provided to the subscriber device 222a, 222b by the content provider 238, the first ID (or second ID, as appropriate) may be included in transactions between the content provider 238 and the subscriber device 222a, 222b (in some examples provided the consent expiry has not been reached). However, the first ID and/or second ID may each be set or controlled to expire, or may be removed from the subscriber device 222a, 222b, after the session in which the content is provided to the subscriber device 222a, 222b by the content provider 238 is terminated. For example, the session may be terminated by the subscriber device 222a, 222b closing a browser, or the content provider 238 terminating the session. Similarly to as described above, this may help allow the content provider 238 to efficiently analyse the subscriber's engagement within a session based on the same ID (e.g. the first ID), but help prevent third parties (e.g. malicious third parties, e.g. via a ‘man-in-the-middle’ attack) from building up a profile of the subscriber based on the first ID or the second ID.

In some examples, the first ID and/or the second ID may each be a ‘per use’ or ‘single use’ ID. For example, the first ID and/or the second ID may each be used for only one transaction between the content provider 238 and the subscriber device 222a, 222b (e.g. the provision of content by the content provider 238 to the subscriber device 222a, 222b). For example, as described above, the first ID and/or the second ID may be generated by the content provider 238 (or the subscriber device 222a, 222b) when the content provider 238 provides content to the subscriber device 222a, 222b, and the subscriber device 222a, 222b may include the first ID and/or second ID into the first message 332 and/or the second message 342, respectively, sent to the first entity 224. However, in some examples, the first ID and/or the second ID may not be stored at the subscriber device 222a, 222b for subsequent use (e.g. for use in subsequent transactions between the subscriber device 222a, 222b and the content provider 238). For example, this may occur in cases where it is not permitted to store the first ID and/or the second ID at the subscriber device 222a, 222b for such subsequent use, or for example in cases where the first ID and/or the second ID are removed by the subscriber device 222a, 222b. In some examples, the first ID and/or second ID may each be set or controlled to expire, or may be removed from the subscriber device 222a, 222b, after the first message 332 and/or the second message 342, respectively, is sent to the first entity 224. The first ID and/or the second ID being “per use” or “single use” IDs may ensure that third parties (e.g. malicious third parties, e.g. via a ‘man-in-the-middle’ attack) cannot build up a profile of the subscriber based on the first ID or the second ID.

In the above examples, it was described that providing the association information to the content provider 238 (and in turn allowing the content provider 238 to associate different instances of subscriber engagement) may allow for the content provider 238 to provide continuity between different instances of subscriber engagement and/or provide more accurate analytics. However, other uses may be made of the association information.

Specifically, in some examples, the content provider 238 may determine one or more browsing attributes indicating an attribute of the engagement of the subscriber with the content provider 238 in a particular instance (e.g. the first instance A or the second instance B). These browsing attributes may be stored by the content provider 238 in association with the first ID (or the second ID) with which the instance correlates. In some examples, the browsing attributes may simply indicate that the subscriber engaged with the content provider 238. In some examples, the attributes may comprise a particular piece of content (or an identifier for the particular piece of content) that was delivered to the subscriber device during the engagement, one or more characteristics of the particular piece of content that was delivered to the subscriber device, the duration of the engagement by the subscriber and/or the level of engagement of the subscriber with the content. Any other attributes of the subscriber's engagement with the content provider in the particular instance may be used.

In some examples, the content provider 238 may categories the first IDs (or second IDs) of each instance of engagement by category of browsing attribute. For example, the content provider 238 may compile a list of all first IDs (and second IDs) that correlate to an instance of engagement of a subscriber with the content provider 238 in which the subscriber navigated to or otherwise viewed a specific web-page, for example relating to a specific car. The content provider 238 may provide this list to the second entity 234. Alternatively, the content provider may provide a list of first IDs (and second IDs) and their associated browsing attributes to the second entity, and the second entity may compile, for each of one or more browsing attributes or combination of browsing attributes, a list of all first IDs (and second IDs) that have the one or more browsing attributes or combination of browsing attributes. In either case, in some examples, the second entity 238 may determine the subscriber identifiers for the list of first IDs (and second IDs) based the stored associations therebetween at the second entity. The second entity 238 may then store the one or more browsing attributes in association with the subscriber identifiers to which they correspond.

For example, for a subscriber having the first and second instances A, B of engagement with a particular content provider 238, the method may comprise at the second entity 234, receiving, from the third entity 240, the first ID and/or the second ID in association with a browsing attribute indicating an attribute of said engagement of the subscriber with the content provider 238 in the first and/or second instance, A, B respectively. The method may then comprise, at the second entity 234, determining the identifier for the subscriber (e.g. first subscriber identifier or second subscriber identifier) associated with the browsing attribute based on the received first ID and/or second ID and the stored association between the first ID the second ID and the identifier for the subscriber. The method may then comprise, at the second entity 234, storing the browsing attribute in association with the identifier for the subscriber.

As described above, this may be carried out for multiple subscribers. In this way, the second entity 234 may segment subscribers based on one or more specific browsing attributes. For example, the second entity 234 may determine the first subscriber ID (and/or second subscriber ID) for all those subscribers having a common browsing characteristic, for example all those subscribers that navigated to or otherwise viewed the specific web-page, for example relating to the specific car. This segmentation may be used, for example, to retarget advertising to particular subscriber segments. For example, as described in more detail below, the second entity 224 may provide segment information, indicating the browsing attribute, to an advertising entity, for the advertising entity to use in providing a targeted advert to a subscriber. In some examples, the segmentation based on browsing attributes may be combined with other segmentation based on other data. For example, this may be combined with segmentation of subscribers based on subscriber attributes stored at the service provider network 224, or from other data sources.

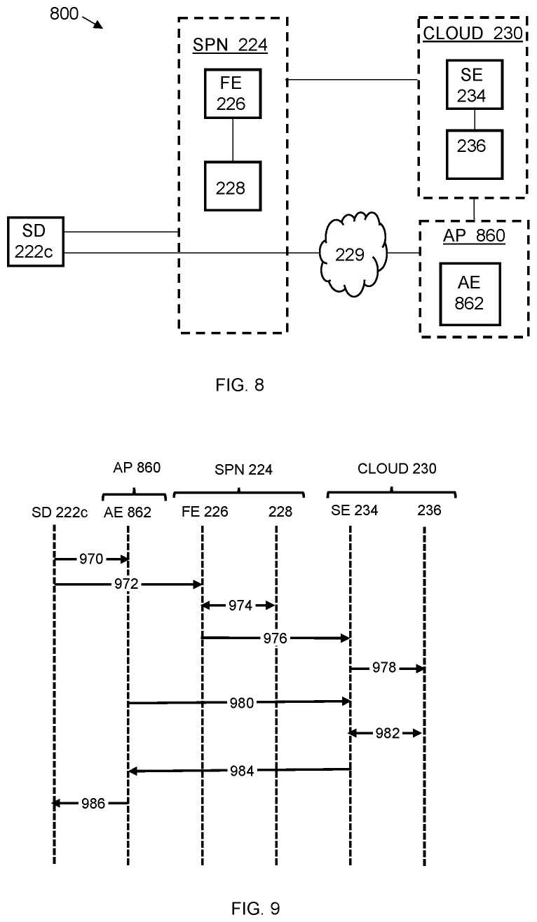

An example implementation in which the segmentation of subscribers based on one or more specific browsing attributes may be used to retarget advertising is described with reference to FIGS. 8 and 9. FIG. 8 illustrates an example telecommunications network 800 in which the retargeting may be implemented, and FIG. 9 illustrates example signalling between the components of the system.

Referring to FIG. 8, the telecommunications network 800 comprises the service provider network 224 comprising the first entity 226 and the storage 228, the internet 229, the cloud 230 comprising the second entity 234 and the storage 236, and a subscriber device 222c. The subscriber device 222c may be the same or different to the subscriber device 222a, 222b of the system 200 described above with reference to FIG. 1. In this example, the network 800 also comprises an advertising platform 860 comprising an advertising entity 862 (e.g. ad server). For example, the advertising platform 860 may comprise a demand side platform (DSP). The DSP may be configured to bid on and, if won, fulfil requests for advertisements from the subscriber device 222c. Although not shown in FIG. 8 for clarity, the network 800 may comprise other components, such as the content provider 238 and/or other components of the telecommunications network 200 described above with reference to FIG. 1.

FIG. 9 illustrates example signalling between the components of the network 600 in an example method for providing targeted advertising.

Prior to the signalling illustrated in FIG. 9, the content provider (not shown in FIGS. 8 and 9) has instructed the advertising platform 660 to target a particular advert to a particular segment of subscribers. For example, the content provider may wish to target an advert for a particular car at subscribers having a browsing attribute indicating that they have navigated to or otherwise viewed content, at the content provider, relating to the particular car. As described above, the content provider 238 may have provided a list of first IDs (and second IDs) for instances of engagement where the subscriber viewed the content relating to the particular car, and the second entity 234 may have determined the subscribers identifiers from the first IDs (and second IDs) and stored the browsing attribute in association with those subscriber identifiers. In some examples, the content provider may also desire the targeting to be based on other attributes, such as the age of the subscriber, which may for example be known to the service provider network 224. In order to bid appropriately on ad requests to fill with an ad relating to the specific car, it would be useful for the advertising platform 860 to know whether a particular ad request is from a subscriber that has viewed the content relating to the specific car (and in some examples is from a subscriber meeting the desired age criteria). However, this should be done without revealing to the advertising platform 860 the identity of the subscriber, and in a way that would not allow the advertising platform 860 (or any other third party) to build up a profile of a subscriber based on multiple such ad requests.

Referring now to FIG. 9, in an example method for providing targeted advertising, the subscriber device 222c sends an ad request 970 to the advertising entity 862 of the advertising platform 860. For example, when the subscriber device 222c downloads a webpage with advertising space to fill, the subscriber device 222c may be caused by code in the webpage to send an ad request to fill the advertising space with an advert. This process may be facilitated by programmatic advertising. For example, the ad request 970 may be sent from the subscriber device 222a to a supply side platform SSP (not shown) to fill the advertising space. The SSP (not shown) may in turn send a bid request to the DSP (and possibly other DSPs, not shown) to place a bid on the advertising space for fulfilling the ad request with content that the DSP provides. In any case, the ad request 970 is transmitted to the advertising entity 862.

The ad request 970 includes a token. The token may be a Universally Unique ID. A new token may be randomly generated by the subscriber device 222c for each ad request 970 that it sends. As such, the token included in the ad request, for practical purposes, uniquely identifies the ad request 970 amongst all other ad requests. The token may be associated with an expiry, for example a Time To Live (TTL), which may define a length of time for which the token may be used. The generated token may be included into the ad request 970 by the subscriber device 222c. For example, the website downloaded by the subscriber device 222c may include code (or a link to code) that causes the subscriber device 222c to generate the token and include it into the ad request 970.

The ad request 970 may be sent from the subscriber device 222c to the advertising entity 862 using an encrypted communications channel, e.g. by using HTTPS protocol. Therefore, even where the ad request 970 is transmitted to the advertising entity 862 via the service provider network 224, the service provider network 224 may not be able to read the content of the ad request, e.g. may not be able to read the token.

At the same or similar time to the ad request 970, the subscriber device 222c also transmits a fourth message 972 to the first entity 226 of the service provider network 224. The fourth message 972 includes a token that correlates to the token included into the ad request 970. For example, the fourth message 972 may include a copy of the token that was included into the ad request 970. The fourth message 972 may be a synchronisation request. The subscriber device 222c may be caused by code included or linked in the downloaded website to include a copy of the generated token into the fourth message 970 and transmit it to the first entity 226.

The first entity 226 identifies 974 the subscriber of the subscriber device 222c based on the fourth message 772, for example with reference to the storage 228. For example, the first entity 226 may identify the subscriber based on the fourth message 772 in the same or similar way to as for the first message 332 and the second message 342, 442 described above with reference to FIGS. 1 to 4. For example, the first entity 225 may determine the first subscriber identifier for the subscriber. The first entity may determine an identifier for the subscriber based on the identification of the subscriber. For example, the first entity 226 may determine the second subscriber identifier for the subscriber based on the first identifier for the subscriber, for example as described above. In some examples, the first entity 226 may also look-up subscriber information associated with the identified subscriber in the storage 228 of the service provider network 224. For example, the storage 228 may comprise a customer relationship management (CRM) database storing information on each subscriber, such as their age, gender, and the like.

The first entity 226 transmits 976 the determined identifier for the subscriber (e.g. second subscriber identifier for the subscriber) and the token to the second entity 234. For example, the first entity 226 may modify the fourth message 972 so as to include the second subscriber identifier, and transmit the modified fourth message 976 to the second entity 234. In some examples, the first entity 226 may also transmit subscriber information, such as attribute-value pairs for the identified subscriber as determined from the look-up in the storage 228, to the second entity 234. For example, the first entity 226 may include the subscriber information into the modified fourth message 976.

The second entity 234 stores 978 the token in association with the identifier for the subscriber in the storage 236 of the cloud 230. In examples where subscriber information (e.g. age) is also transmitted, the second entity 234 may store 978 the token and the subscriber information in association with the identifier for the subscriber. In some examples, the token may be stored in association with the identifier for the subscriber in a cache associated with the second entity 234. In some examples, for a given subscriber, the storage 236 at the cloud 230 may store the identifier for the subscriber, the browsing attribute provided by the content provider (e.g. whether or not the subscriber has viewed the specific car), the subscriber information provided by the service provider network (e.g. the age of the subscriber), and the token for the ad request, in association with one another.

The advertising entity 862, having received the ad request 970, determines whether to fulfil the ad request with the advert provided by the content provider. For example, a DSP of the advertising entity 862 may determine how much to bid for the right to fulfil the ad request with an advert provided by the content provider. In order to inform this determination, the advertising entity 862 provides 980 the token that was included in the ad request 970, to the second entity 234. For example, the token may be provided 980 using a HTTP request from the advertising entity 662 to the second entity 234. In some examples, the receipt of the request 980 may be interpreted as a request to provide the segment information stored in association with the provided token (e.g. in the cache of the second entity 234). In some examples, the token may be provided with a request for specific segment information of the subscriber that requested the advert. For example, the request for segment information may include a request for data on whether the subscriber is one with a specific browsing attribute (i.e. has viewed the content relating to the specific car) and has an age that satisfies a given age range. As another example, the request for segment information may be a request to provide the browsing attributes and other subscriber information stored at the second entity 234 in association with the provided token.

In any case, in response to receiving the token from the advertising entity 862, the second entity 234 performs a look-up 982 for a match against a stored token.

For example, where the token is stored in the cache in association with the identifier for the subscriber, the second entity 234 may use the cache to determine the identifier for the subscriber. The second entity 234 may then use the determined identifier for the subscriber to perform a look-up in the storage 236 for segment information stored in association with determined identifier for the subscriber.

In other examples, where the token is stored in association with the identifier for the subscriber in the storage 236, the second entity 234 may perform a look-up in the storage 236 to determine a match for the provided token, and if there is a match then the associated segment information may be extracted. In some examples, where the token is stored by the second entity 234 also in association with one or more fourth IDs, the second entity 234 may perform a look-up in the storage 236 for segment information stored in association with the one or more fourth IDs.

In any case, if there is a match (and the TTL for the token has not yet expired), then the request 980 for information may be accepted, whereas if there is no match (and/or the TTL for the token has expired) then the request 980 for information may be refused by the second entity 234. In the present example, the token matches against the token stored with the identifier for the subscriber that requested the advert, and the token's TTL has not yet expired. Accordingly, the second entity 234 may provide 984 at least a portion of the extracted segment information to the advertising entity 862. Accordingly, the advertising entity 862 may determine, based on the received segment information, that the ad request 770 was from a subscriber that fulfils the targeting criteria for the advert provided by the content provider. The advertising entity 862 may therefore, for example, bid appropriately to fill the ad request 970 with that advert. Accordingly, the advertising entity 862 may provide 986 the advert in response to the ad request 770.

According to the above, in some examples, the method comprises, at the second entity 234, receiving 980 a token from an advertising entity 862, the token having been provided to the advertising entity 862 by a subscriber device 222c of the subscriber when the subscriber device 222c of the subscriber requests 970 an advert; at the second entity 234, matching the token from the advertising entity 862 with a token stored at the second entity in association with the identifier for the subscriber; and, responsive to the matching of the token, providing 984 to the advertising entity 862 the segment information indicating at least the browsing attribute. In some examples, the segment information may further include subscriber information stored at the second entity 234 in association with the identifier for the subscriber and provided from the service provider network 224.

These examples may allow for the implementation of a system in which an advertising platform 860 is able to target adverts to subscribers based on browsing attributes determined by the content provider (and in some examples also based on subscriber information provided by the service provider network). Moreover, this may be provided for without revealing to the advertising platform 660 (or the content provider) the identity of the subscriber. That is, the advertising platform only knows the token associated with the ad request and the attributes provided by the second entity 234. Moreover, the use of a different tokens generated for each different ad request helps ensure that the advertising platform 660 (or any other third party) cannot build up a profile of a subscriber based on multiple such ad requests.

In some examples, there may be provided a system comprising the first entity 226 within the service provider network 224 and the second entity 234. The first entity 226 and the second entity 234 may be configured to perform the method and/or provide the functionality according to any one of the examples described above with reference to FIGS. 1 to 9. In some examples, the system may comprise any of the components of the telecommunications networks 200, 600 described above with reference to FIGS. 1 to 9.

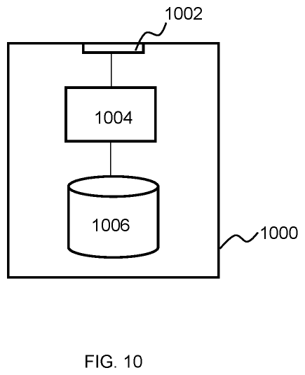

Referring to FIG. 10, there is illustrated an apparatus 1000 according to an example. The apparatus 1000 comprises a processor 1004, a memory 1006, and an input/output interface 1002. Any one of the first entity 226, the second entity 234, the third entity 240, the advertising entity 662, and the subscriber devices 222a, 222b, 222c may be provided by an apparatus such as the example apparatus 1000 of FIG. 10. For example, the memory 1006 may store instructions which when executed by the processor 1004 cause the processor 1004 to perform the functionality of any one of the first entity 226, the second entity 234, the third entity 240, the advertising entity 662, and the subscriber devices 222a, 222b, 222c described above with reference to FIGS. 1 to 9. In examples where the apparatus 1000 embodies the first entity 226, the second entity 234, the third entity 240 or the advertising entity 662, the apparatus 1000 may be embodied, for example, by a web-server. For example, the first entity 226 may be implemented by an Internet Content Adaptation Protocol (ICAP) server.

The above examples are to be understood as illustrative examples of the invention. It is to be understood that any feature described in relation to any one example may be used alone, or in combination with other features described, and may also be used in combination with one or more features of any other of the examples, or any combination of any other of the examples. Furthermore, equivalents and modifications not described above may also be employed without departing from the scope of the invention, which is defined in the accompanying claims.

What is claimed is:

1. A method for associating different instances of engagement of a subscriber of a service provider network with a first content provider, the method comprising:
for a first instance:
at a first entity within the service provider network:
receiving a first message from a subscriber device of the subscriber, the first message comprising a first ID associated with the provision of content from the first content provider to the subscriber device in the first instance;
identifying the subscriber based on the received first message;
determining an identifier for the subscriber based on the identification of the subscriber; and
transmitting the identifier for the subscriber and the first ID to a second entity;
at the second entity:
storing the first ID in association with the identifier for the subscriber;
for a second instance:
at the first entity within the service provider network:
receiving a second message from the subscriber device or another subscriber device of the subscriber, the second message comprising a second ID different to the first ID, the second ID being associated with the provision of content from the first content provider to the subscriber device or the other subscriber device in the second instance;
identifying the subscriber based on the received second message;
determining the identifier for the subscriber based on the identification of the subscriber; and
transmitting the identifier for the subscriber and the second ID to the second entity;
at the second entity:
storing the second ID in association with the identifier for the subscriber and thereby in association with the first ID;
wherein the method further comprises, at the second entity:
providing, to a third entity associated with the first content provider, information indicating the stored association between the second ID and the first ID, thereby to allow the third entity to associate the first instance with the second instance.

2. The method according to claim 1, wherein the first ID is generated when the subscriber device obtains the content from the first content provider in the first instance, and/or the second ID is generated when the subscriber device or the other subscriber device obtains the content from the first content provider in the second instance.

3. The method according to claim 2, wherein the first ID is generated by the first content provider and provided to the subscriber device when the subscriber device obtains the content from the first content provider in the first instance; and/or the second ID is generated by the first content provider and provided to the subscriber device or the other subscriber device when the subscriber device or the other subscriber device obtains the content from the first content provider in the second instance.

4. The method according to claim 1, wherein
the first ID is stored as a cookie on the subscriber device by the first content provider; and/or
the second ID is stored as a cookie on the subscriber device or the other subscriber device by the first content provider.

5. The method according to claim 1, wherein
the content obtained by the subscriber device from the first content provider in the first instance includes code or a link to code that causes the subscriber device to send the first message to the first entity in the service provider network; and/or
the content obtained by the subscriber device or the other subscriber device from the first content provider in the second instance includes code or a link to code that causes the subscriber device or the other subscriber device to send the second message to the first entity in the service provider network.

6. The method according to claim 1, wherein the second message is received from the other subscriber device, and wherein the second ID is associated with the provision of content from the first content provider to the other subscriber device in the second instance.

7. The method according to claim 1, wherein the second message is received from the subscriber device, wherein the second ID is associated with the provision of content from the first content provider to the subscriber device in the second instance, and wherein the second instance is at a different time to the first instance.

8. The method according to claim 1, wherein the second entity is external to the service provider network, and wherein:
for the first instance:
identifying the subscriber based on the first message at the first entity comprises determining a first subscriber identifier for the subscriber that identifies the subscriber within the service provider network;
determining the identifier for the subscriber based on the identification of the subscriber comprises deriving, based on the first subscriber identifier, a second subscriber identifier for the subscriber that identifies the subscriber at the second entity; and
wherein the method comprises: at the first entity, modifying the first message to include the second subscriber identifier; and sending the modified first message to the second entity for the second entity to use in storing the first ID in association with the identifier for the subscriber; and
for the second instance:
identifying the subscriber based on the second message at the first entity comprises determining the first subscriber identifier for the subscriber;
determining the identifier for the subscriber based on the identification of the subscriber comprises deriving, based on the first subscriber identifier, the second subscriber identifier for the subscriber; and
wherein the method comprises: at the first entity, modifying the second message to include the second subscriber identifier; and sending the modified second message to the second entity for the second entity to use in storing the second ID in association with the identifier for the subscriber.

9. (canceled)

10. (canceled)

11. The method according to claim 1, wherein the first message and the second message each include a third ID identifying the first content provider from which the content is provided, and wherein the method comprises:
for the first and second instance:
at the second entity, storing the third ID in association with the first ID and the second ID, respectively.

12. The method according to claim 9, wherein providing the information indicating the association between the second ID and the first ID to the third entity is responsive to a determination that the first ID and the second ID are stored in association with the third ID.

13. The method according to claim 1, wherein the first message and the second message include consent information associated with the first ID and the second ID, respectively, the consent information for the first ID and the second ID indicating whether or not the subscriber consents to the use of their identification by the service provider network for the first ID and the second ID, respectively; and wherein the method comprises:
for the first and second instance:
at the second entity, storing the consent information for the first ID in association with the first ID and storing the consent information for the second ID in association with the second ID, respectively.

14. The method according to claim 13, wherein providing the information indicating the association between the second ID and the first ID to the third entity is responsive to a determination, based on the stored consent information for the first ID and the second ID, that there is a valid consent for the use of the identification of the subscriber by the service provider network for the first ID and the second ID.

15. The method according to claim 12, wherein the consent information for the first ID comprises a consent expiry for the first ID and the consent information for the second ID comprises a consent expiry for the second ID, and wherein determining that there is a valid consent for the first ID and the second ID is based on a comparison of the stored consent expiry for the first ID and the second ID with a current time.

16. (canceled)

17. (canceled)

18. (canceled)

19. The method according to claim 1, wherein the method comprises:
at the second entity, receiving, from the third entity, the first ID and/or the second ID in association with a browsing attribute indicating an attribute of said engagement of the subscriber with the content provider in the first and/or second instance, respectively;
at the second entity, determining the identifier for the subscriber associated with the browsing attribute based on the received first ID and/or second ID and the stored association between the first ID, the second ID and the identifier for the subscriber;
at the second entity, storing the browsing attribute in association with the identifier for the subscriber; and
at the second entity, providing, to an advertising entity, segment information indicating at least the browsing attribute.

20. The method according to claim 14, wherein the method comprises:
at the second entity, receiving a token from the advertising entity, the token having been provided to the advertising entity by a subscriber device of the subscriber when the subscriber device of the subscriber requests an advert; and
at the second entity, matching the token from the advertising entity with a token stored at the second entity in association with the identifier for the subscriber;
wherein providing to the advertising entity the segment information indicating at least the browsing attribute is responsive to the matching of the token.

21. A system for associating different instances of engagement of a subscriber of a service provider network with a first content provider, the system comprising:
a first entity within a service provider network; and
a second entity,
wherein, the first entity is configured to:
for a first instance, receive a first message from a subscriber device of the subscriber, the first message comprising a first ID associated with the provision of content from the first content provider to the subscriber device in the first instance; identify the subscriber based on the received first message; determine an identifier for the subscriber based on the identification of the subscriber; and transmit the identifier for the subscriber and the first ID to the second entity; and
for a second instance, receive a second message from the subscriber device or another subscriber device of the subscriber, the second message comprising a second ID different to the first ID, the second ID being associated with the provision of content from the first content provider to the subscriber device or the other subscriber device in the second instance; identify the subscriber based on the received second message; determine an identifier for the subscriber based on the identification of the subscriber; and transmit the identifier for the subscriber and the second ID to the second entity;
wherein the second entity is configured to:
for the first instance, store the first ID in association with the identifier for the subscriber;
for the second instance, store the second ID in association with the identifier for the subscriber and thereby in association with the first ID; and
provide, to a third entity associated with the first content provider, information indicating the stored association between the second ID and the first ID, thereby to allow the third entity to associate the first instance with the second instance.

22. A method for associating different instances of engagement of a subscriber of a service provider network with a first content provider, the method comprising, at a second entity:
for a first instance:
storing a first ID in association with an identifier for the subscriber, the first ID having been included in a first message received from a subscriber device by a first entity within the service provider network, the subscriber having been identified, by the first entity, based on the first message, the identifier for the subscriber having been determined, by the first entity, based on the identification of the subscriber, the first ID and the identifier for the subscriber having been transmitted by the first entity to the second entity, the first ID being associated with the provision of content from the first content provider to the subscriber device in the first instance;
for a second instance:
storing a second ID in association with the identifier for the subscriber and thereby in association with the first ID, the second ID having been included in a second message received from the subscriber device or another subscriber device by the first entity, the subscriber having been identified, by the first entity, based on the second message, the identifier for the subscriber having been determined, by the first entity, based on the identification of the subscriber, the second ID and the identifier for the subscriber having been transmitted by the first entity to the second entity, the second ID being associated with the provision of content from the first content provider to the subscriber device or the other subscriber device in the second instance; and
wherein the method further comprises, at the second entity:
providing, to a third entity associated with the first content provider, information indicating the stored association between the second ID and the first ID, thereby to allow the third entity to associate the first instance with the second instance.

23. A method for associating different instances of engagement of a subscriber of a service provider network with a first content provider, the method comprising, at a third entity associated with the first content provider:
for a first instance:
recording a first ID associated with the provision of content from the first content provider to a subscriber device in a first instance;
for a second instance:
recording a second ID associated with the provision of content from the first content provider to the subscriber device or another subscriber device in a second instance;
receiving, from a second entity, information indicating an association between the first ID and the second ID, the first ID and the second ID having been stored by the second entity in association with an identifier for the subscriber, the subscriber having been identified, by a first entity within the service provider network, based on a first message, comprising the first ID, received from a subscriber device and based on a second message, comprising the second ID, received from the subscriber device or another subscriber device, the identifier for the subscriber having been determined, by the first entity, based on the identification of the subscriber, the first ID and the identifier for the subscriber having been transmitted from the first entity to the second entity, the second ID and the identifier for the subscriber having been transmitted from the first entity to the second entity; and
associating the first instance with the second instance based on the received information indicating the association between the first ID and the second ID.

24. Apparatus configured to perform the method according to claim 17.

25. A computer readable medium having instructions stored thereon which, when executed by a computer system, cause the computer system to perform the method according to claim 1.
